(19) United States
(12) Patent Application Publication
(10) Pub. No.: US 2005/0018242 A1
(43) Pub. Date: Jan. 27, 2005

(54) Printer and network print system

(75) Inventor: Osamu Azami, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/864,300

(22) Filed: Jun. 9, 2004

(30) Foreign Application Priority Data
Jun. 9, 2003 (JP) P .2003-163734

(51) Int. Cl. G06F 15/00

(52) U.S. Cl. 358/1.15

(57) ABSTRACT

The present invention aims to provide a network print system including a plurality of printers, wherein the communication traffic for collecting information is small and a setting change job of a computer for collecting job information, etc., is also easy to conduct. In the print network system of the present invention, each of printers making up a network print system is an apparatus for transmitting printer state information (error, status, job report) to a specified computer in accordance with a specified schedule (steps S101 to S110). Setting for transmitting the printer state information to the same computer in the network print system is made for each printer.

### BACKGROUND OF THE INVENTION

1. Field of the Invention

This invention relates to a printer connected to a network for use and a network print system including a plurality of printers connected to a network.

2. Description of the Related Art

As a network system including a plurality of printers connected, used in an office, etc., which will be hereinafter referenced to as network print system, a network print system is known wherein a program for collecting job information, consumable information, and error/warning information from each printer is installed in one computer contained in the system to facilitate management of the printers (for example, patent document 1: JP-A-2000-309147). A network print system is also known wherein a computer (print server) having a function of relaying print job data from each host computer to each printer is installed and is also provided with a function of managing job information and a function of collecting and managing consumable information and error/warning information from each printer.

The described network print system makes it possible to manage the printers in one computer, so that the printers can be managed easily.

However, the described network print system requests each printer to output job information, etc., and therefore the communication traffic for collecting information is comparatively large. After the program for collecting job information, etc., is installed in the computer, various setting jobs must be executed and therefore the job at the startup time and the change job of the computer for collecting job information, etc., are also cumbersome to a considerable extent.

### SUMMARY OF THE INVENTION

It is therefore an object of the invention to provide a network print system including a plurality of printers, wherein the communication traffic for collecting information is small and a special setting job need not be conducted for a computer for collecting job information, etc.

It is another object of the invention to provide printers for making it possible to construct such a network print system.

To the ends, according to the invention, there is provided a printer being connected to a network for use, the printer including printer state information transmission means for transmitting printer state information, information indicating the own state at the point in time, to a computer on the network; information storage means for storing computer specification information, information specifying the computer to which the printer state information transmission means transmits the printer state information, and transmission schedule information, information specifying an operation schedule of the printer state information transmission means; and information rewrite means for rewriting the computer specification information and the transmission schedule information stored in the information storage means as specified by a user.

The described printer of the invention operates as an apparatus for transmitting the printer state information to the specified computer according to the specified schedule. Thus, in a network print system including the two or more printers, the user (system manager) simply uses the information rewrite means of each printer to set transmission schedule information and computer specification information specifying the computer used to collect information (printer management computer) for each printer, whereby the system function for enabling a plurality of printers to be managed in the printer is started. The network print system thus set (namely, network print system as claimed in claim 6) is a system wherein each printer is not requested to output the printer state information (job information, consumable information, etc.,), so that the system functions as a system wherein the communication traffic for collecting information is comparatively small. Further, the network print system becomes a system for eliminating the need for settings including installation of a program for collecting information from each printer in the computer used to collect information (printer management computer), and thus also functions as a system wherein system startup work and change work of the computer used to collect information (printer management computer) are easy to conduct (computer change can be made simply by moving the printer state information).

To implement the printer of the invention, it is desirable that the printer state management information transmission means should be means for transmitting text information as the printer state management information. The reason is as follows: If the printer state management information is any information other than text information, the parties to which the printer state management information is to be transmitted are limited to only computers capable of displaying the information (or a program for displaying the information needs to be installed in the computer to which the printer state management information is to be transmitted); whereas, if the printer state management information is text information, almost all computers can display text information and therefore the parties to which the printer state management information is to be transmitted are not limited (a program for displaying the information needs not be installed in the computer to which the printer state management information is to be transmitted).

To implement the printer of the invention, it is desirable that the printer state information transmission means should be means capable of transmitting the printer state information using any of a plurality of protocols, that the information storage means should be means for storing the computer specification information, the transmission schedule information, and protocol specification information, information specifying the protocol used by the printer state information transmission means to transmit the printer state information, and that the information rewrite means should be means for rewriting the computer specification information, the transmission schedule information, and the protocol specification information stored in the information storage means as specified by the user. The reason is as follows: If the printer of the invention is thus implemented, the selection range of a computer used to manage the printers (computer used to collect the printer state information) is widened.

Further, means for storing managed printer information made up of several pieces of printer determination information, information according to which different printers connected to the network can be determined in addition to the computer specification information, the transmission schedule information, and the protocol specification information may be adopted as the information storage means, means for rewriting the computer specification information, the transmission schedule information, the protocol specification information, and the managed printer information stored in the information storage means as specified by the user may be adopted as the information rewrite means, and the printer may further include printer state information acquisition and transmission means operating in synchronization with the printer state information transmission means for acquiring from a different printer determined by each piece of printer determination information in the managed printer information stored in the information storage means, information indicating the state of the printer at the point in time, and transmitting the acquired information as the printer state information concerning the printer to the computer specified by the computer specification information stored in the information storage means using the protocol specified by the protocol specification information stored in the information storage means.

If the described printer of the invention is used together with several second printers that can respond to a request from the printer state information acquisition and transmission means in a state in which information specifying the printer management computer is stored in the information storage means of the printer as the computer specification information and information containing the printer determination information concerning each second printer is stored as the managed printer information (if the described printer of the invention is handled as the first printer and the configuration of the network print system as claimed in claim 7 is adopted), a network print system including a plurality of printers wherein the communication traffic for collecting information is small and change work of the computer used to collect job information, etc., is also easy can be implemented using the existing printers (second printers) intact.

The configuration for implementing the printer of the invention as that having the function of transmitting the printer state information concerning a different printer is not limited to that described above (as claimed in claim 3). The printer state information transmission means can also be means for acquiring at the operation time from a different printer determined by each piece of printer determination information in the managed printer information stored in the information storage means, information indicating the state of the printer at the point in time, and transmitting combined information of the acquired information and the own state at the point in time as the printer state information to the computer specified by the computer specification information stored in the information storage means using the protocol specified by the protocol specification information stored in the information storage means.

To implement the printer of the invention, the printer may further include second-kind printer state information transmission means for transmitting second-kind printer state information, information indicating a different state from the state indicated by the printer state information, of the own printer, to a computer on the network; second-kind information storage means for storing second-kind computer specification information, information specifying the computer to which the second-kind printer state information transmission means transmits the second-kind printer state information, and second-kind transmission schedule information, information specifying an operation schedule of the second-kind printer state information transmission means; and second-kind information rewrite means for rewriting the second-kind computer specification information and the second-kind transmission schedule information stored in the second-kind information storage means as specified by the user.

If the printer of the invention is thus configured, a network print system wherein information different in use, such as job information and consumable information, is retained in different computer can be implemented.

### BRIEF DESCRIPTION OF THE DRAWINGS

FIG. 1 is a drawing to show the configuration of a printer according to a first embodiment of the invention;

FIG. 2 is a schematic representation of a report transmission condition set page that the printer according to the first embodiment of the invention causes a computer to display;

FIG. 3 is a flowchart of report transmission processing executed in the printer according to the first embodiment of the invention;

FIGS. 4A and 4B are schematic representations of a network print system that can be constructed using the printer according to the first embodiment of the invention;

FIG. 5 is a drawing to show the configuration of a printer according to a second embodiment of the invention;

FIG. 6 is a schematic representation of a managed printer set page that the printer according to the second embodiment of the invention causes a computer to display;

FIG. 7 is a flowchart of report transmission processing executed in the printer according to the second embodiment of the invention;

FIG. 8 is a flowchart of report transmission processing executed in the printer according to the second embodiment of the invention;

FIG. 9 is a flowchart of report transmission processing executed in the printer according to the second embodiment of the invention;

FIGS. 10A and 10B are schematic representations of a network print system that can be constructed using the printer according to the second embodiment of the invention; and

FIG. 11 is a schematic representation of a network print system that can be constructed using the printer according to the second embodiment of the invention.

In the drawings, each reference numeral 10, 40 refers to a printer; 11, 41 to a control section; 12, 42 to an operation panel; and 13, 43 to a print mechanism section.

### DETAILED DESCRIPTION OF THE PREFERRED EMBODIMENTS

Referring now to the accompanying drawings, there are shown preferred embodiments of the invention.

<First Embodiment>

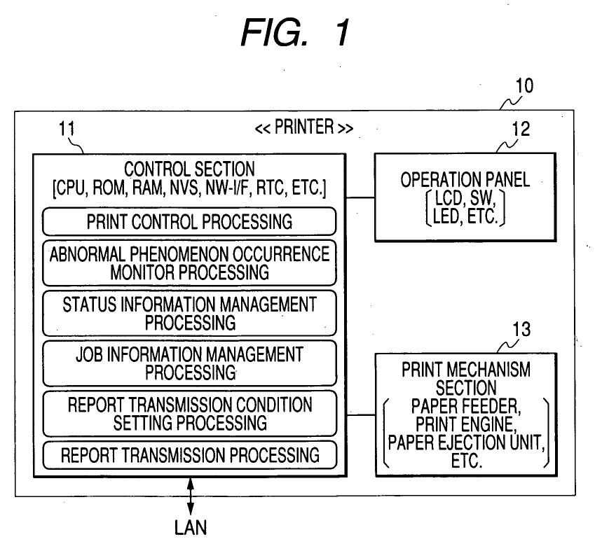

A printer 10 according to a first embodiment of the invention includes a control section 11 made up of a CPU, ROM, RAM, NVS (nonvolatile storage: HDD, RAM with battery backup, or the like), an NW I/F (network interface circuit), an RTC (real-time clock), etc., an operation panel 12 made up of a liquid crystal display (LCD), a plurality of pushbutton switches (SWs), a plurality of light emitting diodes (LEDs), etc., and a print mechanism section 13 made up of a paper feeder, a print engine, a paper ejection unit, etc., as schematically shown in FIG. 1. The printer 10 also includes a unit for concurrently executing print control processing, abnormal phenomenon occurrence monitor processing, status information management processing, job information management processing, report transmission condition information setting processing, report transmission processing, etc., as the control section 11.

The print control processing executed by the control section 11 is processing of monitoring reception of print job data and causing the print mechanism section 13 to generate printed matter specified in the received print job data. The abnormal phenomenon occurrence monitor processing is processing of monitoring occurrence of an abnormal phenomenon in the printer 10 and if an abnormal phenomenon occurs, displaying a message indicating occurrence of the abnormal phenomenon on the operation panel 12 (LCD), etc. The status information management processing is processing of managing the remaining amounts of the consumables in the printer 10, the number of times the periodical replacement parts have been used, the user-setup values concerning various operation condition items, and the like (status information).

The job information management processing includes processing of storing (recording) job information concerning print job data processed by the print control processing (information made up of various pieces of item information such as the transmission source computer name, the number of print sheets, and the print date and time) in the NVS (nonvolatile storage) in the control section 11.

The report transmission condition setting processing is processing of changing error report transmission condition information, status report transmission condition information, and job report transmission condition information (described later in detail) stored in the NVS to those as specified by the manager of the printer 10.

Specifically, the control section 11 executing the report transmission condition setting processing usually monitors reception of an HTTP request of a predetermined description, which will be hereinafter referred to as set page request, and reception of report transmission condition specification information (described later in detail).

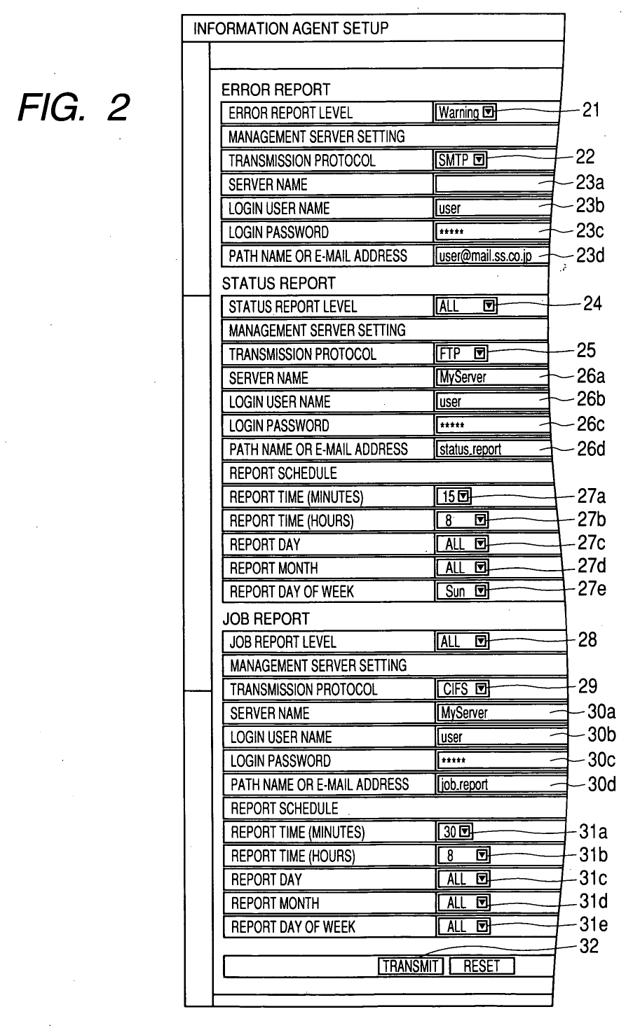

Upon reception of the set page request, the control section 11 causes the computer transmitting the set page request to display a report transmission condition set page in the format shown in FIG. 2.

The report transmission condition set page is a Web page where the initial values of select boxes 21, 22, 24, 25, 27a to 27e, 28, 29, and 31a to 31e and text boxes 23a to 23d, 26a to 26d, and 30a to 30d are those responsive to the error report transmission condition information, the status report transmission condition information, and the job report transmission condition information stored in the NVS. The report transmission condition set page is a Web page where the information received by the control section 11 containing the current values in the items (containing the values set by the manager of the printer 10) is transmitted to the network when the user presses a TRANSMIT button 32.

The information transmitted as the TRANSMIT button 32 is pressed is the report transmission condition specification information. Upon reception of the report transmission condition specification information, the control section 11 changes the error report transmission condition information, the status report transmission condition information, and the job report transmission condition information stored in the NVS to those responsive to the report transmission condition specification information.

The transmission condition information rewritten by performing the processing will be discussed instead of describing the processing in detail.

The error report transmission condition information is information containing error report level information, error report transmission protocol specification information, error report destination specification information, and error report authentication information.

The error report level information contained in the error report transmission condition information is information specifying the condition to transmit an error report (a file retaining information indicating what error/warning occurred in the printer 10 (described later in detail)) according to the type of abnormal phenomenon (error/warning). The error report level information is information corresponding to the setup value in the select box 21 and can take a value specifying transmission of an error report when an error or a warning occurs, a value specifying transmission of an error report only when an error occurs (suppressing transmission of an error report when a warning occurs), or a value specifying transmission of no error report (non-transmission indication value).

The error report transmission protocol specification information is information specifying the protocol to be used to transmit an error report. The error report transmission protocol specification information is information corresponding to the setup value in the select box 22 and takes any of a value indicating transmission of an error report using FTP (File Transfer Protocol), a value indicating transmission of an error report using CIFS (Common Internet File System), or a value indicating transmission of an error report using SMTP (Simple Main Transfer Protocol).

The error report destination specification information is information specifying the destination of an error report. The error report destination specification information is information corresponding to the setup values in the text boxes 23a and 23d. The error report authentication information is information required for the receiving party at the destination to receive the error report and may be information containing no significant is information. The error report authentication information is information corresponding to the setup values in the text boxes 23b and 23c.

On the other hand, the status report transmission condition information is information containing status report level information, status report transmission protocol specification information, status report destination specification information, status report authentication information, and status report schedule specification information.

The status report level information contained in the status report transmission condition information is information specifying the type of status information (information managed in the status information management processing) to be contained in a status report to be transmitted (a file containing various pieces of status information indicating the state of the printer 10 (described later in detail)). The status report level information is information corresponding to the setup value in the select box 24 and can take a non-transmission indication value specifying transmission of no status report like the error report level information.

The status report transmission protocol specification information is information specifying the protocol to be used to transmit a status report. The status report transmission protocol specification information is information corresponding to the setup value in the select box 25 and takes any of a value indicating transmission of a status report using FTP, a value indicating transmission of a status report using CIFS, or a value indicating transmission of a status report using SMTP like the error report transmission protocol specification information.

The status report destination specification information is information specifying the destination of a status report. The status report destination specification information is information corresponding to the setup values in the text boxes 26a and 26d. The status report authentication information is information required for the receiving party at the destination to receive the status report and may be information containing no significant information. The status report authentication information is information corresponding to the setup values in the text boxes 26b and 26c. The status report schedule specification information is information to specify the transmission schedule of a status report. The status report schedule specification information is information corresponding to the setup values in the select boxes 27a to 27e.

The job report transmission condition information is information containing job report level information, job report transmission protocol specification information, job report destination specification information, job report authentication information, and job report schedule specification information.

The job report level information contained in the job report transmission condition information is information corresponding to the setup value in the select box 28 to specify what item information of job information to be transmitted as a job report (a file containing job information recorded by performing the job information management processing (described later in detail)). The job report level information can take a non-transmission indication value specifying transmission of no job report like the error report level information and the status report level information.

The job report transmission protocol specification information is information corresponding to the setup value in the select box 29 to specify the protocol to be used to transmit a job report. The job report transmission protocol specification information also takes any of a value indicating transmission of a job report using FTP, a value indicating transmission of a job report using CIFS, or a value indicating transmission of a job report using SMTP like any other transmission protocol specification information.

The job report destination specification information is information corresponding to the setup values in the text boxes 30a and 30d to specify the destination of a job report. The job report authentication information is information required for the receiving party at the destination to receive the job report and may be information containing no significant information. The job report authentication information is information corresponding to the setup values in the text boxes 30b and 30c. The job report schedule specification information is information corresponding to the setup values in the select boxes 31a to 31e to specify the transmission schedule of a job report.

The report transmission processing executed by the control section 11 is processing of transmitting an error report, a status report, a job report in the conditions indicated by the error report transmission condition information, the status report transmission condition information, the job report transmission condition information as described above and is also processing again executed if the error, status, or job report transmission condition information is changed.

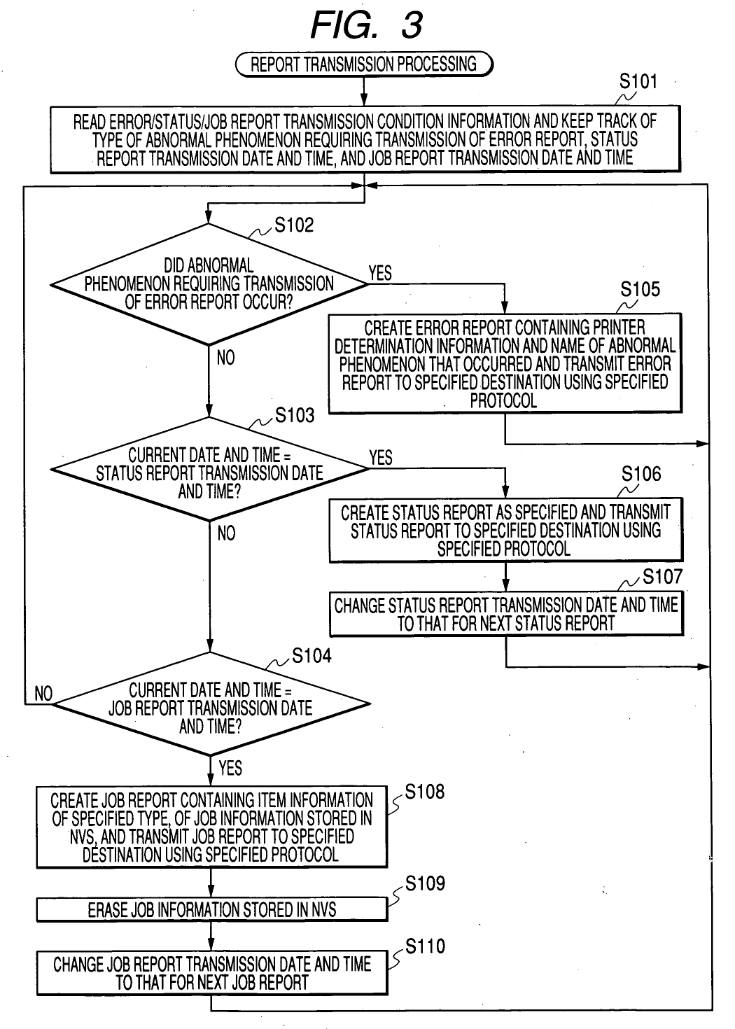

The report transmission processing will be discussed in detail with a flowchart of FIG. 3.

As shown in the figure, the control section 11 starting the report transmission processing first reads the error report transmission condition information, the status report transmission condition information, and the job report transmission condition information stored in the NVS into the RAM and keeps track of the type of abnormal phenomenon (error or warning) to transmit an error report, the status report transmission date and time of the next transmission date and time of a status report, and the job report transmission date and time of the next transmission date and time of a job report (step S101). More particularly, the control section 11 performs the following processing at step S101:

First, the control section 11 reads the error report transmission condition information, the status report transmission condition information, and the job report transmission condition information stored in the NVS into the RAM. Then, the control section 11 performs processing of determining and storing the type of abnormal phenomenon to transmit an error report based on error report level information (element information of the error report transmission condition information) read into the RAM, processing of determining the next transmission date and time of a status report (the transmission date and time of the first status report to be transmitted after execution of step S101) based on status report transmission schedule specification information (element information of the status report schedule specification information) read into the RAM and the current date and time (output of the RTC) and storing the transmission date and time as the status report transmission date and time, and processing of determining the next transmission date and time of a job report (the transmission date and time of the first job report to be transmitted after execution of step S202) based on job report transmission schedule specification information (element information of the job report schedule specification information) read into the RAM and the current date and time (output of the RTC) and storing the transmission date and time as the job report transmission date and time.

The control section 11 performing the processing at step S101 starts monitor processing of detection of an abnormal phenomenon (error/warning) to transmit an error report in abnormal phenomenon occurrence monitor processing, and the current date and time matching the status report date and time or the job report date and time (loop process made up of steps S102 to S104). Although not shown in the flowchart, the control section 11 also determines whether or not the level information concerning each report takes the non-transmission indication value. If a report whose level information takes the non-transmission indication value exists, the control section 11 executes the loop process at steps S102 to S104 while skipping the determination as to the report whose level information takes the non-transmission indication value.

When the control section 11 recognizes occurrence of an abnormal phenomenon to transmit an error report in the loop process of steps S102 to S104 (YES at step S102), the control section 11 creates an error report containing information concerning the abnormal phenomenon that occurred and transmits the error report to the destination specified by the error report destination specification information (in the figure, specified destination) using the protocol specified by the error report transmission protocol specification information (in the figure, specified protocol) (step S105).

Specifically, at step S105, the control section 11 creates as the error report, a text file containing the model name, the MAC address, and the IP address of the printer 10 (printer determination information) and the name of the abnormal phenomenon that occurred and having the file name listing a predetermined character string (a character string to indicate that the file is an error report from the file name), the model name, the IP address, and the current date and time. If the protocol specified by the error report transmission protocol specification information is FTP or CIFS, the control section 11 transmits the created error report (text file) to the destination specified by the error report destination specification information (if necessary, using the error report authentication information). On the other hand, if the protocol specified by the error report transmission protocol specification information is SMTP, the control section 11 transmits electronic mail with information equivalent to the above-mentioned file name set as “subject” to which the created error report (text file) is attached to the destination specified by the error report destination specification information using the error report authentication information.

The control section 11 performing the processing at step S105 starts processing at step S102 and again enters the state of monitoring occurrence of an abnormal phenomenon to transmit an error report and the current date and time matching the status report transmission date and time or the job report transmission date and time.

On the other hand, upon detection of the current date and time matching the status report transmission date and time (YES at step S103), the control section 11 creates a status report containing status information of the type specified by the status report level information and transmits the status report to the destination specified by the status report destination specification information using the protocol specified by the status report transmission protocol specification information (step S106).

Specifically, at step S106, the control section 11 creates as the status report, a text file containing printer determination information (information made up of the model name, the MAC address, and the IP address) on the first row (rows are information units separated by line feed) and text information status information of the types specified by the status report level information together with the names, such as “total number of print sheets: xxxxx” and “toner remaining amount: −yy %,” on the second and later rows and having the file name listing a predetermined character string (a character string to indicate that the file is a status report from the file name), the model name, the IP address, and the current date and time. If the protocol specified by the status report transmission protocol specification information is FTP or CIFS, the control section 11 transmits the created status report (text file) to the specified destination; if the protocol specified by the status report transmission protocol specification information is SMTP, the control section 11 transmits electronic mail with information equivalent to the above-mentioned file name set as “subject” to which the created status report (text file) is attached to the specified destination as at the error report transmission time.

Upon completion of the processing at step S106, the control section 11 changes the status report transmission date and time to the next transmission date and time of the status report based on the status report transmission schedule information (step S1.07) and then again starts processing at step S102.

Upon detection of the current date and time matching the job report transmission date and time (YES at step S104), the control section 11 creates a job report as specified by the job report level information from the job information stored in the NVS by performing the job information record processing and transmits the created job report to the destination specified by the job report destination specification information using the protocol specified by the job report transmission protocol specification information (step S108).

Specifically, at step S108, the control section 11 creates as the job report, a text file in CSV (Comma Separated Value) format containing printer determination information on the first row, job information (containing only item information responsive to the job report level information) on the third and later rows, and the names of the item information of the job information contained on the third and later rows on the second row and having the file name listing a predetermined character string (a character string to indicate that the file is a job report from the file name), the model name, the IP address, and the current date and time. If the protocol specified by the job report transmission protocol specification information is FTP or CIFS, the control section 11 transmits the created status report (text file) to the specified destination; if the protocol specified by the job report transmission protocol specification information is SMTP, the control section 11 transmits electronic mail with information equivalent to the above-mentioned file name set as “subject” to which the created job report (text file) is attached to the specified destination as at the error report or status report transmission time.

Upon completion of the processing at step S108, the control section 11 erases the job information stored in the NVS (step S109) and changes the job report transmission date and time to the transmission date and time of the next job report based on the job report transmission schedule information and the current date and time (step S110) and then again starts processing at step S102.

As described above, the printer 10 according to the first embodiment is an apparatus that can autonomously transmit the three types of reports containing the information concerning the state of the apparatus to the specified apparatus according to the error, status, and job report destination specification information and also enables the user to select the transmission protocol of each report from among FTP, CIFS, and SMTP. Further, the printer 10 is an apparatus for transmitting as each report a text file not requiring any special program to view the contents of the report.

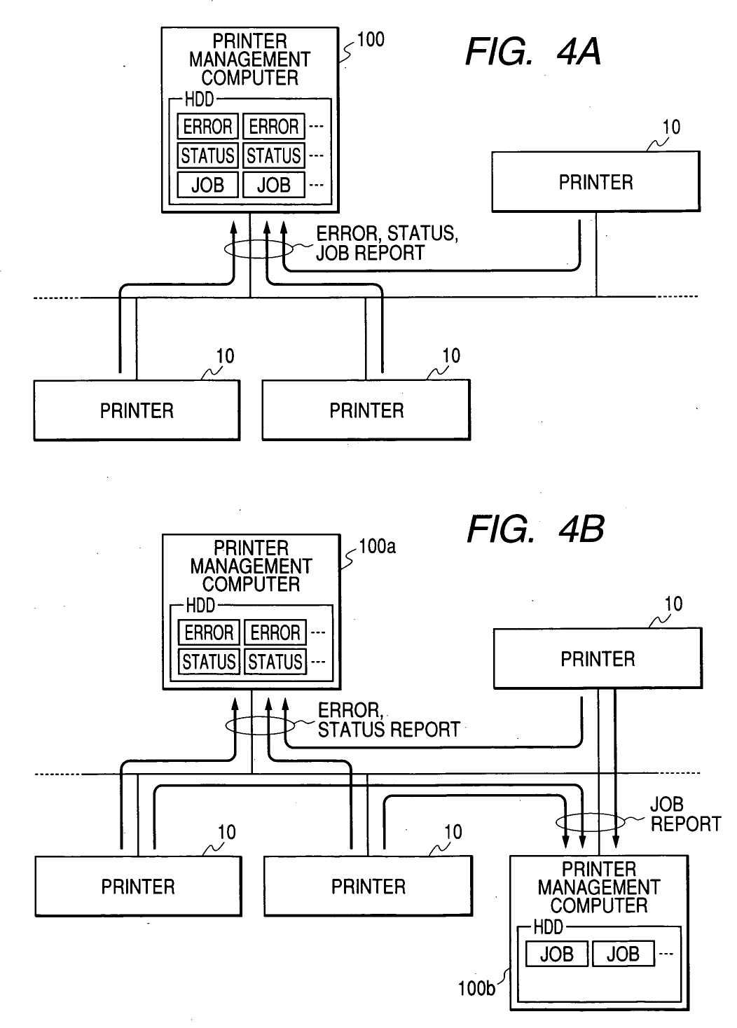

Therefore, as the printer 10 is used, a network print system wherein error reports, status reports, and job reports from each printer 10 are retained in a printer management computer 100, namely, a network print system wherein a plurality of printers 10 can be managed using the printer management computer 100 can be constructed with a computer that can receive information using any of FTP, CIFS, or FTP used intact as the printer management computer 100, as schematically shown in FIG. 4A. Since almost all computers used on a LAN can receive information using any of FTP, CIFS, or FTP, as the printer 10 is used, a network print system wherein a plurality of printers 10 can be managed using the printer management computer 100 can be constructed with a usual computer used intact as the printer management computer 100 (without installing an information collection program).

The printer 10 is an apparatus for enabling the user to specify the report destination for each type of report. As the printer 10 is used, a network print system wherein error reports and status reports from each printer 10 are retained in a printer management computer 100a and job reports from each printer 10 are retained in a printer management computer 100b, namely, a network print system wherein management for causing the printer 10 to operate in the normal state can be conducted using the printer management computer 100a and charging management can be conducted using the printer management computer 100a can also be constructed with usual computers used intact as the printer management computers 100a and 100b, as schematically shown in FIG. 4B.

<Second Embodiment>

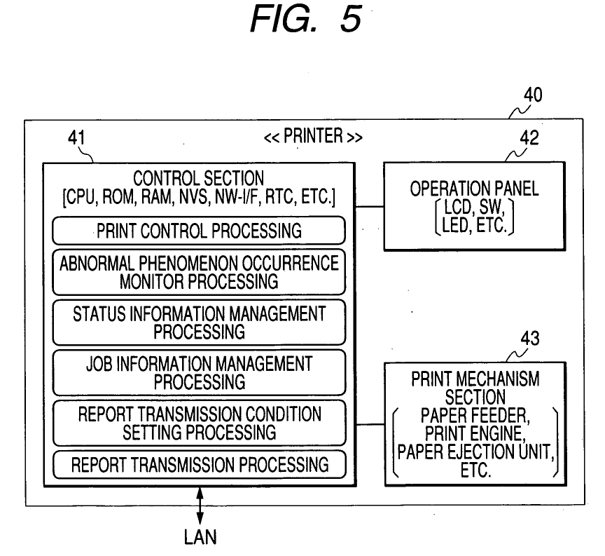

A printer 40 according to the second embodiment of the invention includes a control section 41 made up of a CPU, ROM, RAM, NVS (nonvolatile storage: HDD, RAM with battery backup, or the like), an NW I/F (network interface circuit), an RTC (real-time clock), etc., an operation panel 42 made up of a liquid crystal display (LCD), a plurality of pushbutton switches (SWs), a plurality of light emitting diodes (LEDs), etc., and a print mechanism section 43 made up of a paper feeder, a print engine, a paper ejection unit, etc., as schematically shown in FIG. 5. The printer 40 also includes a unit for concurrently executing print control processing, abnormal phenomenon occurrence monitor processing, status information management processing, job information management processing, report transmission condition information setting processing, report transmission processing, etc., as the control section 41.

The print control processing, abnormal phenomenon occurrence monitor processing, status information management processing, and job information management processing executed by the control section 41 are the same as those executed by the control section 11. On the other hand, the report transmission condition setting processing and the report transmission processing executed by the control section 41 differ from those executed by the control section 11. Thus, the description to follow centers on the operation differences between the control sections 41 and 11 for the report transmission condition setting processing and the report transmission processing.

To begin with, the operation of the control section 41 for the report transmission condition setting processing will be discussed.

The control section 41 executing the report transmission condition setting processing usually monitors reception of a set page request, report transmission condition specification information, a managed printer selection page request, and managed printer specification information.

The set page request and report transmission condition specification information whose reception is monitored by the control section 41 are the same as those whose reception is monitored by the control section 11. The operation of the control section 41 at the reception time of the set page request and report transmission condition specification information is also the same as the operation of the control section 11 at the reception time of the set page request and report transmission condition specification information.

On the other hand, the managed printer selection page request whose reception is monitored by the control section 41 (whose reception is not monitored by the control section 11) is an HTTP request of a predetermined description different from the set page request.

Upon reception of the managed printer selection page request, the control section 41 first performs processing of examining the model name, the MAC address, the IP address, etc., of each printer (selectable printer) manufactured by the same manufacturer as the own printer 40, existing on the same LAN (broadcast domain) as the own printer 40. Every selectable printer is an apparatus which supports the SNTP and can transmit a trap notification when a warning occurs and a trap notification when an error occurs. Some selectable printers (selectable printers of specific models) have a function of recording job information and responding to various requests concerning job information (mainly, job information output request) from a different apparatus.

The control section 41 examining the model name, the MAC address, the IP address, etc., of each selectable printer performs managed printer set page providing processing for providing a managed printer set page for the computer transmitting a set page request, which will be hereinafter referred to as communicating computer.More particularly, the control section 41 creates source data (HTML data) responsive to the examination information and the managed printer specification information stored in the NVS and transmits the source data to the communicating computer as the managed printer set page providing processing.

The managed printer specification information referenced at the time of the managed printer set page providing processing is information containing information made up of the model name, the MAC address, and the IP address, which will be hereinafter referred to as managed printer determination information, for each of one or more managed printers (printers selected by the manager from among the selectable printers (described later in detail)).

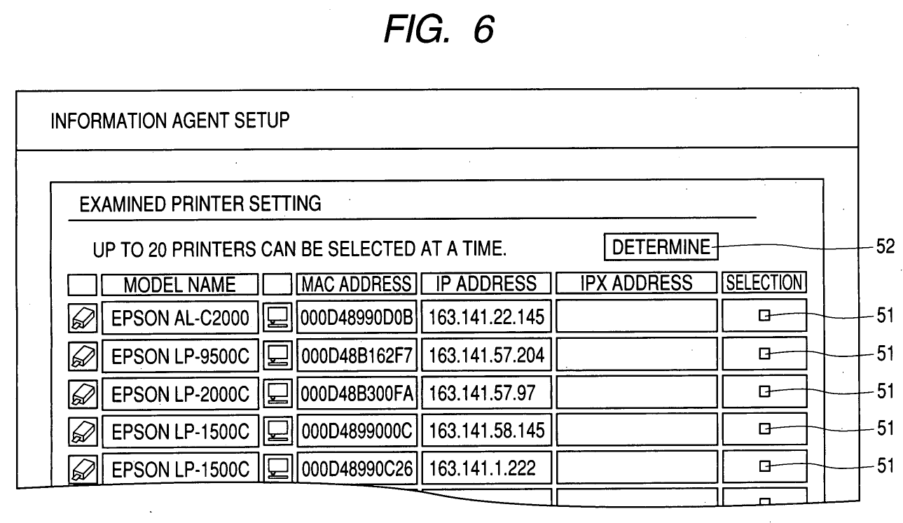

On the other hand, the managed printer set page provided by performing the managed printer set page providing processing is a Web page displaying a SET button 52 and is also a Web page displaying the model name, the MAC address, a check box 51, etc., for each selectable printer, as shown in FIG. 6. Each check box 51 displayed on the managed printer set page is an item to select the selectable printer corresponding to the check box as the managed printer. In the managed printer set page providing processing, the managed printer specification information is referenced and the initial value of each check box 51 is determined.

The SET button 52 on the managed printer set page is an item for the communicating computer (Web browser) to transmit information containing the current value of each check box 51 (information indicating whether or not the check box is checked) and received by the control section 41 to the network as the user presses the SET button 52.

The information transmitted as the user presses the SET button 52 is managed printer set indication information. Upon reception of the managed printer set indication information, the control section 41 changes the managed printer set specification information stored in the NVS to that responsive to the managed printer set indication information.

Next, the operation of the control section 41 for the report transmission processing will be discussed.

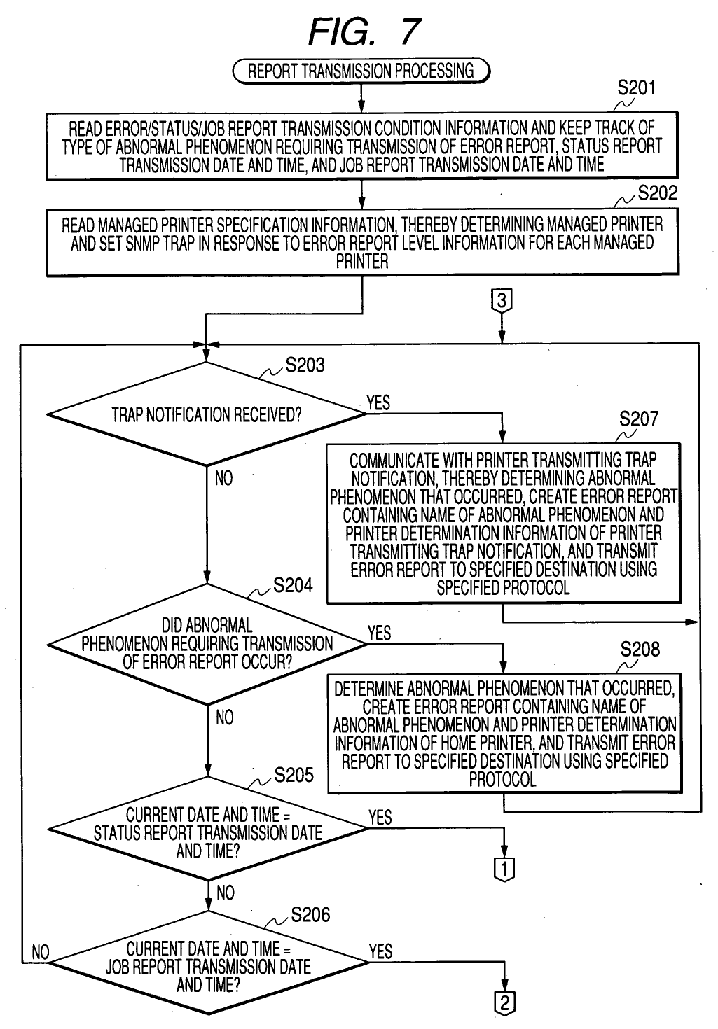

FIGS. 7 to 9 are flowcharts of show the report transmission processing executed by the control section 41. The report transmission processing is also processing again executed if the error, status, or job report transmission condition information is changed like the report transmission processing executed by the control section 11 (FIG. 3).

As shown in FIGS. 4A and 4B, the control section 41 starting the report transmission processing first reads the error report transmission condition information, the status report transmission condition information, and the job report transmission condition information stored in the NVS into the RAM and keeps track of the type of abnormal phenomenon (error or warning) to transmit an error report, the date and time to transmit a status report (status report transmission date and time), and the date and time to transmit a job report (job report transmission date and time) (step S201). The processing at step S201 is the same as that at step S101 (FIG. 3).

Next, the control section 41 reads the managed printer specification information into the RAM and sets SNMP trap in response to the error report level information for the managed printer determined by the managed printer determination information for each piece of managed printer determination information contained in the managed printer specification information (step S202).

That is, if the error report level information is to specify transmission of an error report when an error or a warning occurs, at step S202, the control section 41 makes setting to cause each managed printer to transmit a trap notification representing occurrence of an error or a trap notification representing occurrence of a warning to the own printer 40. If the error report level information is to specify transmission of an error report when an error occurs, the control section 41 makes setting to cause each managed printer to transmit a trap notification representing occurrence of an error to the own printer 40. If the error report level information is to specify transmission of no error report, the control section 41 makes setting to cause each managed printer not to transmit a trap notification representing occurrence of an error or a warning to the own printer 40.

Upon completion of the processing at step S202, the control section 41 starts monitor processing of reception of a trap notification, detection of an abnormal phenomenon (error/warning) to transmit an error report in abnormal phenomenon occurrence monitor processing, and the current date and time matching the status report date and time or the job report date and time (loop process made up of steps S203 to S206). Although not shown in the flowchart, the control section 41 also determines whether or not the level information concerning each report takes the non-transmission indication value at step S201. If a report whose level information takes the non-transmission indication value exists, the control section 41 executes the loop process at steps S203 to S206 while skipping the determination as to the report whose level information takes the non-transmission indication value.

Upon detection of reception of a trap notification in the loop process made up of steps S203 to S206 (YES at step S203), the control section 41 performs the following processing at step S207:

First, the control section 41 acquires information indicating what the abnormal phenomenon occurring in the managed printer is from the managed printer transmitting the trap notification. The control section 41 acquires the information by SNMP. Next, the control section 41 creates an error report in the same format as that created by the control section 41 based on the acquired information, the managed printer determination information of the managed printer (model name, MAC address, IP address), and the current date and time. The control section 41 transmits the created error report according to the same procedure as the control section 11.

The control section 41 performing the processing at step S207 starts processing at step S203 and again enters the state of monitoring occurrence of various events.

Upon detection of occurrence of an abnormal phenomenon to transmit an error report in the own printer 40 (YES at step S202), the control section 41 performs the same processing as that at step S105 at step S205 and then again starts the loop process at steps S203 to S206.

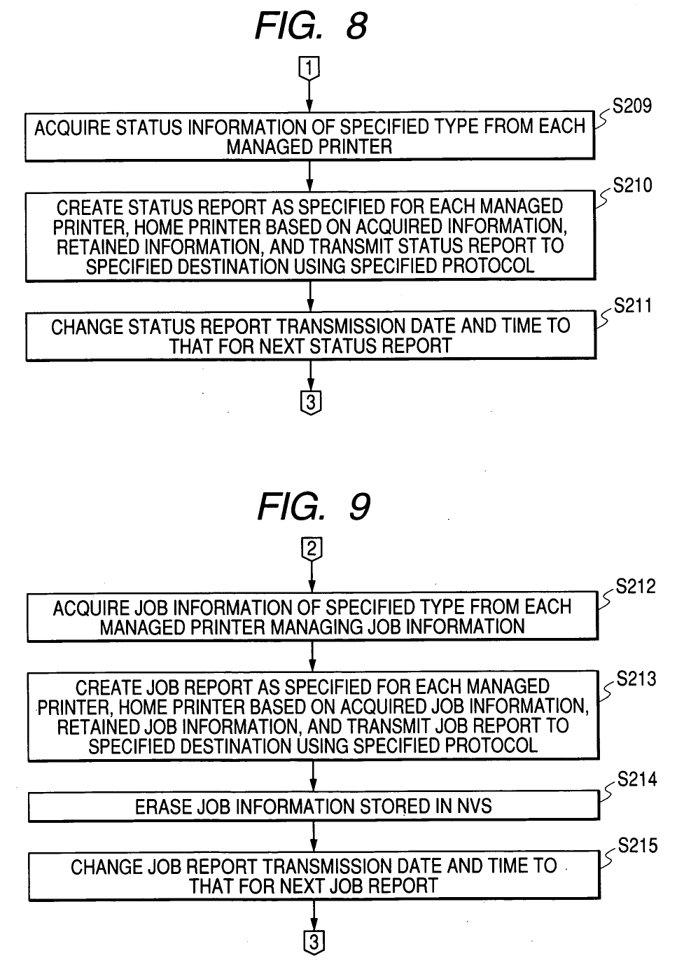

If the current date and time matches the status report transmission date and time (YES at step S204), the control section 41 first acquires status information of the type specified by the status report level information by SNTP from each managed printer (step S209) as shown in FIG. 8. Next, for each managed printer and the own printer, the control section 41 creates status reports in the same format as that created by the control section 11, and transmits the status reports according to the same procedure as the control section 11 (step S210). That is, for each managed printer, the control section 41 creates a status report in the same format as that created by the control section 11 from the status information acquired from the managed printer, the managed printer determination information of the managed printer, and the like and transmits the status report according to the same procedure as the control section 11; for the own printer, the control section 41 creates a status report in the same format as that created by the control section 11 from the status information retained (managed) by the control section (own printer), the printer determination information of the own printer, and the like and transmits the status report according to the same procedure as the control section 11.

Upon completion of transmission of the status report (at step S206), the control section 41 changes the status report transmission date and time to the transmission date and time of the next status report based on the status report transmission schedule information (step S211) and then again starts processing at step S203 (FIG. 7).

If the current date and time matches the job report transmission date and time (YES at step S204), the control section 41 first acquires job information stored in the managed printer from each managed printer having a function of managing job information (step S212) as shown in FIG. 9. At step S412, whether or not each managed printer has the function of managing job information is determined from the model name of the printer and job information is not left in each managed printer.

Next, at step S213, for each managed printer, the control section 41 creates a job report in the same format as that created by the control section 11 from the job information acquired from the managed printer, the managed printer determination information of the managed printer, and the like and transmits the job report according to the same procedure as the control section 11; for the own printer, the control section 41 creates a job report in the same format as that created by the control section 11 from the job information retained (managed) by the control section (own printer) (job information stored in the NVS by performing job information management processing), the printer determination information of the managed printer, and the like and transmits the job report according to the same procedure as the control section 11.

Upon completion of the processing at step S213, the control section 41 deletes the job information stored in the NVS (step S214) and changes the job report transmission date and time to the transmission date and time of the next job report based on the job report transmission schedule information and the current date and time (step S215) and then again starts processing at step S203.

As described above, the printer 40 according to the second embodiment is an apparatus provided by modifying (improving) the printer 10 according to the first embodiment so as to transmit the error, status, job report concerning the own printer and the error, status, job report concerning each different printer (managed printer) to the apparatus specified by the error, status, job report destination specification information.

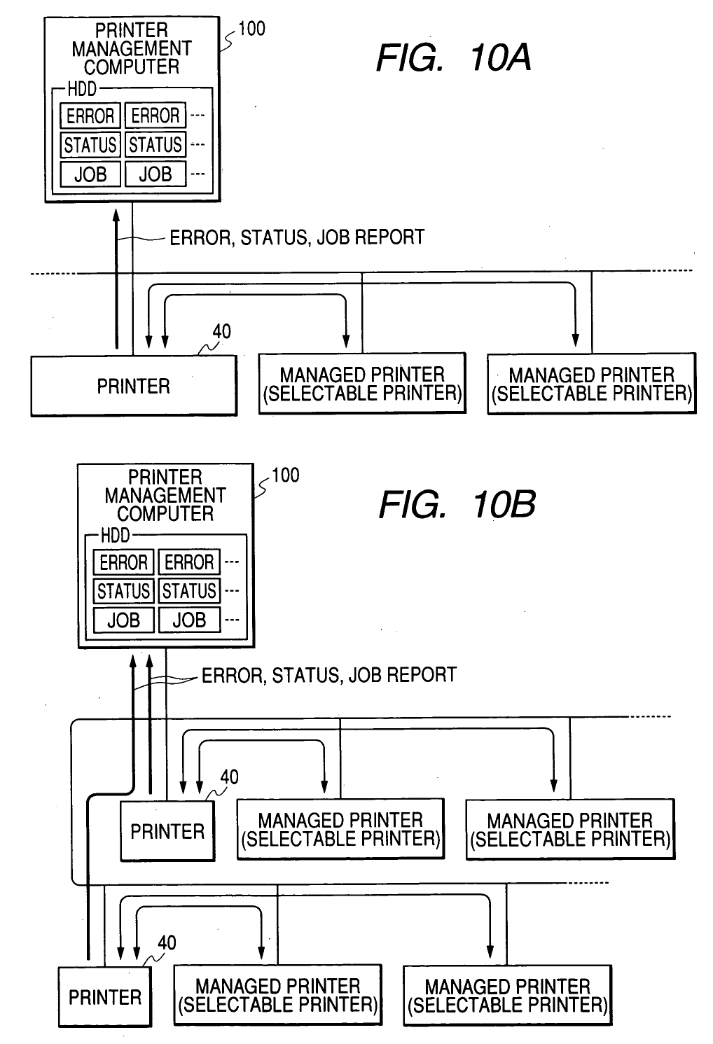

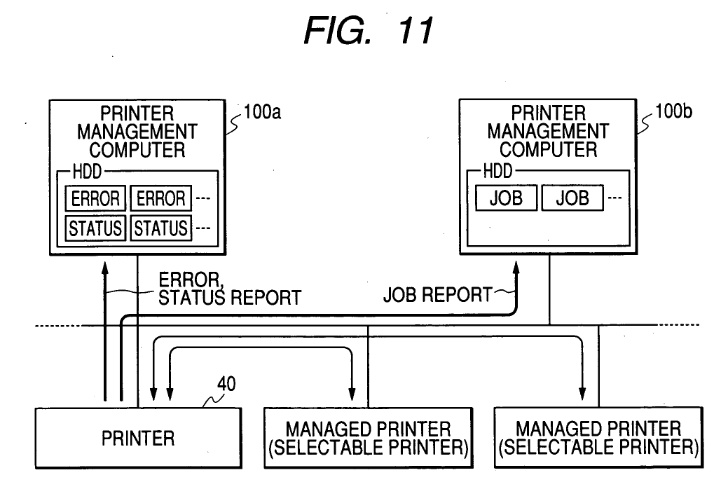

Therefore, as the printer 40 is used, a system wherein error reports, status reports, and job reports to enable the user to keep track of the state of the printer 40 and the state of each managed printer are retained (a system wherein several printers 40 and several selectable printers can be managed using a printer management computer 100) can be constructed in the printer management computer 100 with a usual computer (a computer that can receive information using any of FTP, CIFS, or FTP) used intact as the printer management computer 100 (without installing an information collection program), as shown in FIGS. 10A, 10B.

The printer 40 is also an apparatus for enabling the user to specify the report destination for each type of report like the printer 10. As the printer 40 is used, a system as schematically shown in FIGS. 10A and 10B, namely, a system wherein error reports and status reports concerning the printer 40 and each managed printer are retained in a printer management computer 100a and job reports concerning the printer 40 and each managed printer are retained in a printer management computer 100b, so that management for causing the printer 40 to operate in the normal state can be conducted using the printer management computer 100b and charging management can be conducted using the printer management computer 10a can also be constructed with usual computers used intact as the printer management computers 10a and 10b.

<Modifications>

The printer 10, 40 of the embodiment can be modified in various manners. For example, the status report transmitted by the printer 10, 40 of the embodiment contains information concerning consumables and information concerning any other than consumables, but the printer 10, 40 can be modified so as to transmit a status report containing information only concerning consumables and a status report containing information concerning any other than consumables. The printer 10, 40 may be modified so as to enable the user to specify only one report destination. However, if the printer 10, 40 is thus modified, it is made impossible to construct the system as shown in FIG. 5B, FIG. 11 and therefore it is desirable that the above-described configuration should be adopted.

The printer 10, 40 does not enable the user to specify the contents of an error report (the types of information contained in an error report), but may be modified so as to enable the user to specify the contents of an error report. To thus modify the printer 10, 40, the report transmission condition set page (FIG. 2) may be provided with several check boxes for the user to specify whether or not specific information, such as information concerning the toner remaining amount or information concerning a jam that occurred, is to be contained in an error report (or a select box 21 providing a larger number of selectable values).

The printer 10, 40 is an apparatus for enabling the user to specify the protocol used to transmit a report, but may be modified to an apparatus which does not enable the user to specify a protocol (an apparatus for transmitting a report using the FTP or CIFS). However, if the printer 10, 40 is thus modified, the specifications of the computer for receiving reports are limited and therefore it is desirable that the printer 10, 40 should be as described above.

The printer 40 transmits a report concerning a different printer and a report concerning the own printer 40 separately, but may be modified so as to transmit one report (file) concerning a different printer and the own printer 40. The printer 10, 40 may be modified so as to enable the user to specify the format of the report to be transmitted (for example, plain text, CSV format text, or XML).

The report transmission condition information setting processing executed by the own printer 10, 40 is processing for prompting the user to set various pieces of information by providing the report transmission condition set page, the report transmission condition set page and the managed printer selection page, but may be modified to processing of accepting specification of information indicating the location of the file containing the error report transmission condition information (for example, computer name and full path file name, printer name and file name) and reading the contents of the file specified by the information.

The printer 10, 40 has the RTC, but may be modified to an apparatus for adjusting the time by communicating with another apparatus keeping track of the accurate date and time (an NTP (Network Time Protocol) server, a computer having an RTC, a computer adjusting the time at regular time intervals using an NTP server, or the like) without having the RTC.

1. A printer being connected to a network for use, said printer comprising:
a printer state information transmission section for transmitting printer state information indicating the own state at the point in time, to a computer on the network;
an information storage section for storing computer specification information specifying the computer to which said printer state information transmission section transmits the printer state information, and transmission schedule information specifying an operation schedule of said printer state information transmission section; and
an information rewrite section for rewriting the computer specification information and the transmission schedule information stored in said information storage section as specified by a user.

2. The printer as claimed in claim 1,
wherein said printer state information transmission section transmits text information as the printer state information.

3. The printer as claimed in claim 1,
wherein said printer state information transmission section is capable of transmitting the printer state information using any of a plurality of protocols,
wherein said information storage section stores the computer specification information, the transmission schedule information, and protocol specification information specifying the protocol used by said printer state information transmission section to transmit the printer state information, and
wherein said information rewrite section rewrites the computer specification information, the transmission schedule information, and the protocol specification information stored in said information storage section as specified by the user.

4. The printer as claimed in claim 3,
wherein said information storage section is stores managed printer information made up of several pieces of printer determination information according to which different printers connected to the network can be determined in addition to the computer specification information, the transmission schedule information, and the protocol specification information, and
wherein said information rewrite section rewrites the computer specification information, the transmission schedule information, the protocol specification information, and the managed printer information stored in said information storage section as specified by the user, and
wherein said printer further comprising:
a printer state information acquisition and transmission section operating in synchronization with said printer state information transmission section for acquiring from a different printer determined by each piece of printer determination information in the managed printer information stored in said information storage section, information indicating the state of the printer at the point in time, and transmitting the acquired information as the printer state information concerning the printer to the computer specified by the computer specification information stored in said information storage section using the protocol specified by the protocol specification information stored in said information storage section.

5. The printer as claimed in claim 3,
wherein said information storage section stores managed printer information made up of several pieces of printer determination information, information according to which different printers connected to the network can be determined in addition to the computer specification information, the transmission schedule information, and the protocol specification information,
wherein said information rewrite section rewrites the computer specification information, the transmission schedule information, the protocol specification information, and the managed printer information stored in said information storage section as specified by the user, and
wherein said printer state information transmission section acquires at the operation time from a different printer determined by each piece of printer determination information in the managed printer information stored in said information storage section, said information indicating the state of the printer at the point in time, and transmitting combined information of the acquired information and the own state at the point in time as the printer state information to the computer specified by the computer specification information stored in said information storage section using the protocol specified by the protocol specification information stored in said information storage section.

6. The printer as claimed in any of claims 1 to 5, further comprising:
a second-kind printer state information transmission section for transmitting second-kind printer state information, information indicating a different state from the state indicated by the printer state information, of the own printer, to a computer on the network;
a second-kind information storage section for storing second-kind computer specification information specifying the computer to which the second-kind printer state information transmission section transmits the second-kind printer state information, and second-kind transmission schedule information specifying an operation schedule of the second-kind printer state information transmission section; and
a second-kind information rewrite section for rewriting the second-kind computer specification information and the second-kind transmission schedule information stored in the second-kind information storage section as specified by the user.

7. A network print system comprising:
a plurality of printers; and
a printer management computer,
wherein each of said plurality of printers includes:
a printer state information transmission section for transmitting printer state information indicating the own state at the point in time, to a computer on a network;
an information storage section for storing computer specification information specifying the computer to which the printer state information transmission section transmits the printer state information, and transmission schedule information, information specifying an operation schedule of the printer state information transmission section; and
an information rewrite section for rewriting the computer specification information and the transmission schedule information stored in the information storage section as specified by a user,
wherein information specifying said printer management computer is stored as the computer specification information in the information storage section.

8. A network print system comprising:
a first printer;
one or more second printers; and
a printer management computer,
wherein said first printer includes:
a printer state information transmission section for transmitting printer state information indicating the own state at the point in time, to a computer on a network;
an information storage section for storing computer specification information specifying the computer to which the printer state information transmission section transmits the printer state information, transmission schedule information specifying an operation schedule of the printer state information transmission section, protocol specification information, information specifying the protocol used by the printer state information transmission section to transmit the printer state information, and managed printer information made up of several pieces of printer determination information according to which different printers connected to the network can be determined;
an information rewrite section for rewriting the computer specification information, the transmission schedule information, the protocol specification information, and the managed printer information stored in the information storage section as specified by the user; and
a printer state information acquisition and transmission section operating in synchronization with the printer state information transmission section for acquiring from the printer determined by each piece of printer determination information in the managed printer information stored in the information storage section, the printer state information concerning the printer, and transmitting the acquired printer state information to the computer specified by the computer specification information stored in the information storage section using the protocol specified by the protocol specification information stored in the information storage section,
wherein information specifying said printer management computer is stored as the computer specification information in the information storage section and information containing the printer determination information concerning each of said one or more second printers is stored as the managed printer information.

9. The printer as claimed in claim 1,
wherein the printer state information is prepared by type of printer state.

10. The printer as claimed in claim 1,
wherein the printer state information indicates at least one of:
job information representing print job data processed by the print control processing;
status information representing remaining amounts of the consumables in the printer, the number of times the periodical replacement parts have been used, and the user-setup values concerning various operation condition items; and
error information representing errors and warnings occurred in the printer.
